(19) United States
(12) Patent Application Publication
(10) Pub. No.: US 2026/0169193 A1
(43) Pub. Date: Jun. 18, 2026

(54) HIGH-TEMPERATURE RESISTANT LENS STRUCTURE

(71) Applicant: KANT OPTICAL PTE LTD., TAINAN CITY (TW)

(72) Inventor: CHI-CHOU YUAN, TAINAN CITY (TW)

(21) Appl. No.: 19/387,856

(22) Filed: Nov. 13, 2025

(30) Foreign Application Priority Data
Dec. 18, 2024 (TW) 113149443

(51) Int. Cl. G02B 1/11

(52) U.S. Cl. CPC G02B 1/11

(57) ABSTRACT

A high-temperature resistant lens structure includes a substrate, at least one film layer assembly and a waterproof coating. The film layer assembly is coated on one side of the substrate. The film layer assembly includes at least two first refractive index film layers and at least one second refractive index film layer. The first refractive index film layer has a refractive index lower than that of the second refractive index film layer. The first refractive index film layer and the second refractive index film layer are alternatively disposed. At least one of the first refractive index film layers contains 5wt% to 15wt% of Ta₂O₅ and 85wt% to 95wt% of SiO₂. The waterproof coating is coated on the film layer assembly.

### FIELD OF THE INVENTION

The present invention relates to a lens structure, and more particularly, to a high-temperature resistant lens structure.

### BACKGROUND OF THE INVENTION

In order to increase the transmission of light passing through the lens and to reduce the reflection of light, multiple film layers consisting of high refractive index film layers and low refractive index film layers are coated on the surface of the substrate, meeting the optical properties of the lens.

However, since the thermal expansion coefficients of the substrate, high refractive index film layers and low refractive index film layers differ in an environment with large temperature changes, it is easy to occur stress changes between different materials, which may cause the film layers to be pulled and cracked.

As disclosed in Chinese Patent Publication No. CN116047638A titled “OPTICAL LENS AND MANUFACTURING METHOD THEREOF”, the optical lens includes a lens substrate; a bottom layer attached to the lens substate; and an anti-reflective (AR) film layer attached to one side of the bottom layer, facing away from the lens substrate. The material of the bottom layer includes at least one of silicon dioxide, silicon-aluminum mixture and aluminum oxide. The stress range of the optical lens is 50-200MPa.

The optical lens provided by the above-mentioned patent has the bottom layer between the lens substrate and the anti-reflective (AR) film layer, and the overall stress of the optical lens is about 50-200 Mpa. The optical lens exhibits a relatively low strain-driving force during environmental reliability testing, thereby achieving a surface profile variation of less than 0.2 μm on the coated lens before and after exposure to high-temperature and high humidity conditions for 120 hours.

As disclosed in Chinese Patent Publication No. CN219842572U titled “HIGH-TEMPERATURE RESISTANT RESIN LENS”, the high-temperature resistant resin lens comprises a resin substrate. Either side of the resin substrate is sequentially provided with an anti-reflective (AR) layer, a reinforcement layer, a heat-resistant layer, and an anti-fog layer. The surface of the anti-fog layer has a grooved structure. The grooved structure extends toward the resin substrate. The anti-reflective (AR) layer includes low refractive index layers and high refractive index layers that are alternately arranged in sequence. The low refractive index layer is a mixture of silicon dioxide and aluminum oxide. The high refractive index layer is a mixture of titanium dioxide and tantalum pentoxide. The high-temperature resistant resin lens has good light transmittance and good heat resistance.

However, the above-mentioned patents have the additional bottom layer, or the reinforcement layer and the heat-resistant layer, which may reduce the transmission of light passing through the lens and may increase the chance of light reflection.

### SUMMARY OF THE INVENTION

The primary object of the present invention is to provide a high-temperature resistant lens structure, which takes into account the heat resistance of the lens and maintains the optical property to reduce reflection of the lens, without adding additional film layers.

The high-temperature resistant lens structure provided by the present invention comprises a substrate, at least one film layer assembly, and a waterproof coating. The substrate has a substrate body and a hardened layer. The hardened layer covers the substrate body. The film layer assembly is coated on one side of the substrate. The film layer assembly includes at least two first refractive index film layers and at least one second refractive index film layer. The first refractive index film layer has a refractive index lower than that of the second refractive index film layer. One of the first refractive index film layers, the second refractive index film layer and the other first refractive index film layer are arranged on the substrate in sequence. At least one of the first refractive index film layers contains 5wt% to 15wt% of Ta₂O₅ and 85wt% to 95wt% of SiO₂. The waterproof coating is coated on the film layer assembly.

Furthermore, the at least two first refractive index film layers include a plurality of first refractive index film layers, and the at least one second refractive index film layer includes a plurality of second refractive index film layers. The first refractive index film layers and the second refractive index film layers are alternately coated in sequence and then a last one of the first refractive index film layers is coated.

Furthermore, the refractive index of the first refractive index film layer is between 1.4 and 1.5, and the refractive index of the second refractive index film layer is between 1.8 and 2.5.

Furthermore, the hardened layer is added with a far-infrared material or a far-infrared composite material. The far-infrared material is one of the following: magnesium oxide (MgO), calcium oxide (CaO), barium oxide (BaO), zirconium dioxide (ZrO₂), titanium dioxide (TiO₂), chromium (III) oxide (Cr₂O₃), manganese dioxide (MnO₂), iron(III) oxide (Fe₂O₃), aluminum oxide (Al₂O₃), carbide, silicide, boride, nitride, tantalum (Ta), molybdenum (Mo), tungsten (W), iron (Fe), nickel (Ni), platinum (Pt), copper (Cu), and gold (Au). The far-infrared composite material is a mixture of the far-infrared material and zinc oxide (ZnO).

Furthermore, the second refractive index film layer is one of the following: a zirconium dioxide (ZrO₂) film layer, a titanium dioxide (TiO₂) film layer, a titanium (III) oxide (Ti₂O₃) film layer, and a titanium (III, V) oxide (Ti₃O₅) film layer. The rest of the first refractive index film layers is one of the following: a silicon monoxide film layer, a silicon dioxide film layer, and a composite film layer of silicon monoxide and silicon dioxide.

According to the above technical features, the present invention can achieve the following effects:

1. Adding Ta₂O₅ to the first refractive index film layer composed of silicon dioxide reduces the difference in thermal expansion coefficients between the first refractive index film layer and the second refractive index film layer. When there is a drastic temperature change, such as an increase in temperature, the film layers are not easily separated from each other and have the ability to resist large temperature changes.

2. In the process of forming the hardened layer, a material that can absorb far infrared rays is added, so that users can directly relieve eye fatigue through the mid-infrared rays released by the hardened layer of the substrate.

### BRIEF DESCRIPTION OF THE DRAWINGS

FIG. 1 is a schematic view of the partial structure of a first embodiment of the present invention;

FIG. 2 is a partial enlarged view of FIG. 1;

FIG. 3 is a flow chart for manufacturing a high-temperature resistant lens structure of the present invention;

FIG. 4 is a schematic view of the present invention when in use, wherein a substrate is heated in a heating space and a plurality of far-infrared radiation sources surround the substrate;

FIG. 5 is a schematic view showing that a light source is used to illuminate a lens so that the image of the lens is projected onto a plane;

FIG. 6 is a diagram showing a first image displayed on the plane when the light source is used to illuminate the heated high-temperature resistant lens structure of the present invention;

FIG. 7 is a diagram showing a second image displayed on the plane when the light source is used to illuminate a conventional lens that has been heated;

FIG. 8 is a schematic view of the partial structure of a second embodiment of the present invention;

FIG. 9 is a schematic view of the partial structure of a third embodiment of the present invention; and

FIG. 10 is a schematic view of the partial structure of a fourth embodiment of the present invention.

### DETAILED DESCRIPTION OF THE PREFERRED EMBODIMENTS

Embodiments of the present invention will now be described, by way of example only, with reference to the accompanying drawings.

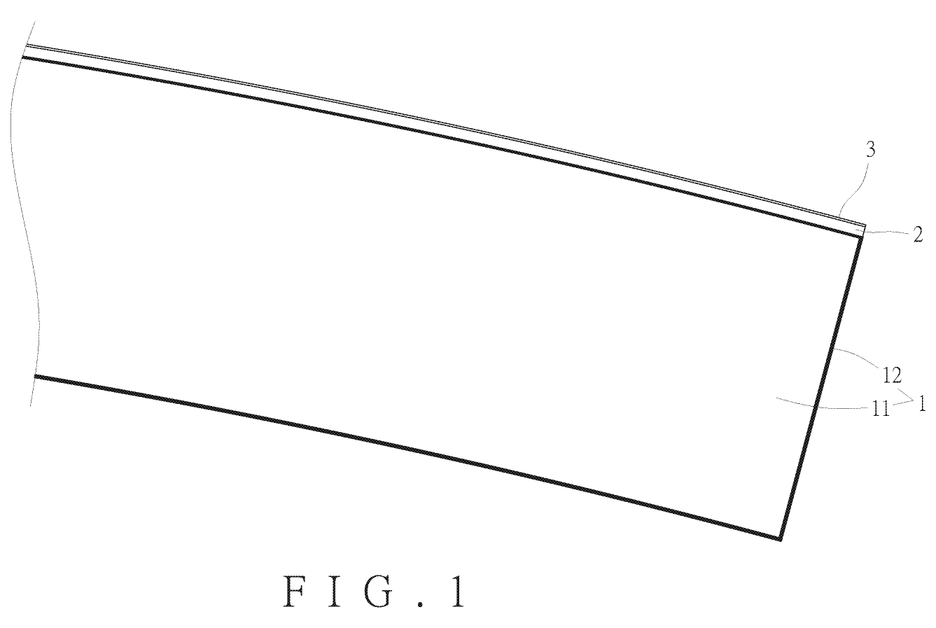

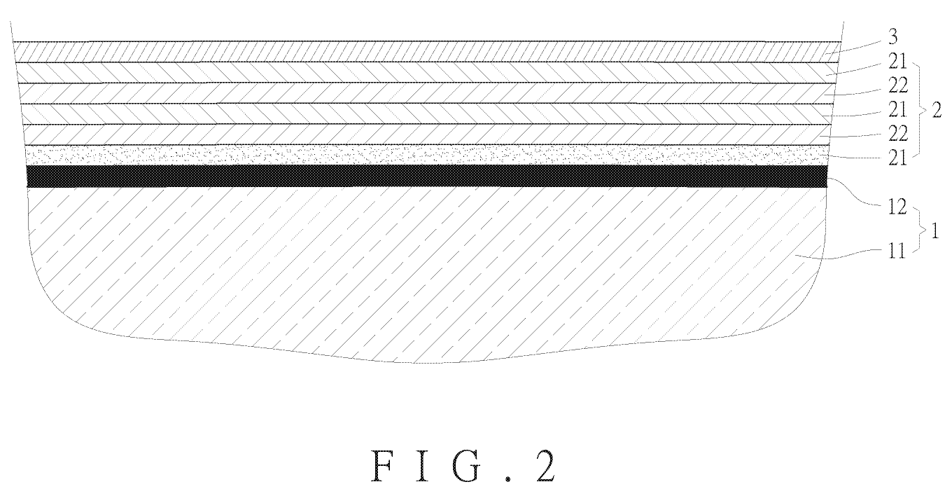

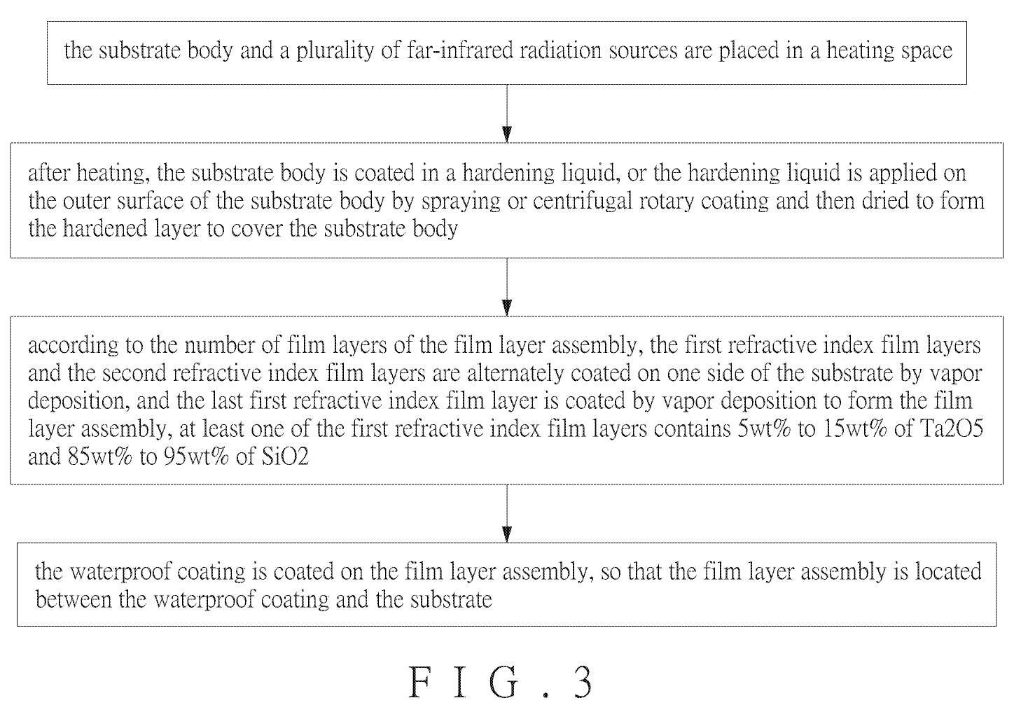

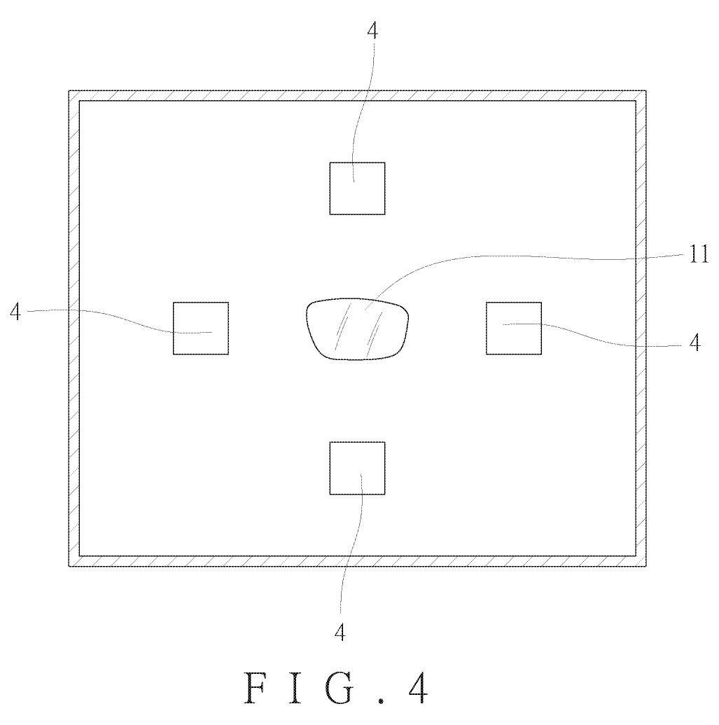

As shown in FIGS. 1-4, the present invention discloses a high-temperature resistant lens structure, comprising a substrate 1, a film layer assembly 2 and a waterproof coating 3.

The substrate 1 has a substrate body 11 and a hardened layer 12. The hardened layer 12 covers the substrate body 11. Specifically, in fabricating the substrate 1, the substrate body 11 and a plurality of far-infrared radiation sources 4 are first placed in a heating space at a temperature between 40 degrees Celsius and 115 degrees Celsius for a period of time between 1 and 3 hours, so that the substrate body 11 is exposed to irradiation by the far-infrared radiation sources 4.

In the heating process, a gradual temperature increase is applied. The temperature is progressively raised within a range of 40 to 115 degrees Celsius over a period of 1 to 3 hours. This process includes segmented heating from low to high temperatures, with each temperature increment being maintained for a period of time. For example, for the temperature to be raised to 115 degrees Celsius, the temperature can be raised by 10 degrees for 10 minutes at a time until it reaches 115 degrees Celsius, or, it is heated directly from low temperature to high temperature and maintained at the highest temperature for a period of time. Specifically, for example, the temperature is directly raised to 115 degrees Celsius and then kept at this temperature for 1 to 3 hours. The above two temperature-raising embodiments are exemplary embodiments of the present invention, but not limited thereto.

After heating, the substrate body 11 is immersed in a hardening liquid, such that the hardening liquid is coated on the substrate body 11. In addition to the immersion method, the hardening liquid may be applied on the outer surface of the substrate body 11 by spraying or centrifugal rotary coating and then dried to form the hardened layer 12 to cover the substrate body 11.

Specifically, the hardening liquid includes a silicone and any one of the following: an isopropyl alcohol and a methanol, wherein the weight percentage of the silicone is between 19 and 33, and the weight percentage of the isopropyl alcohol or methanol is between 62 and 76. In addition, the hardening liquid is added with a far-infrared material or a far-infrared composite material. The far-infrared material is one of the following: magnesium oxide (MgO), calcium oxide (CaO), barium oxide (BaO), zirconium dioxide (ZrO₂), titanium dioxide (TiO₂), chromium (III) oxide (Cr₂O₃), manganese dioxide (MnO₂), iron(III) oxide (Fe₂O₃), aluminum oxide (Al₂O₃), carbide, silicide, boride, nitride, tantalum (Ta), molybdenum (Mo), tungsten (W), iron (Fe), nickel (Ni), platinum (Pt), copper (Cu) and gold (Au). The far-infrared composite material is a mixture of the far-infrared material and zinc oxide (ZnO).

When the hardening liquid is to be dried, the substrate body 11 is placed in the heating space at a temperature between 80 degrees Celsius and 120 degrees Celsius for a period of time between 1 and 10 hours, such that the hardening liquid is dried to form the hardened layer 12 on the substrate body 11. The thickness of the hardened layer 12 is between 1 and 3 micrometers.

The film layer assembly 2 is coated on one side of the substrate 1 by vapor deposition. In this embodiment, the film layer assembly 2 includes three first refractive index film layers 21 and two second refractive index film layers 22, a total of five film layers. The refractive index of the first refractive index film layer 21 is lower than that of the second refractive index film layer 22. The first refractive index film layer 21, the second refractive index film layer 22, the first refractive index film layer 21, the second refractive index film layer 22 and the first refractive index film layer 21 are arranged in sequence on the substrate 1. In this embodiment, one of the first refractive index film layers 21 deposited on the substrate 1 contains 5wt% to 15wt% of Ta₂O₅ and 85wt% to 95wt% of SiO₂, but not limited thereto. In other embodiments, two or three of the first refractive index film layers 21 contain 5wt% to 15wt% of Ta₂O₅ and 85wt% to 95wt% of SiO₂. Specifically, the refractive index of the first refractive index film layer 21 is between 1.4 and 1.5, and the refractive index of the second refractive index film layer 22 is between 1.8 and 2.5. The first refractive index film layers 21 and the second refractive index film layers 22 are sequentially coated on the substrate 1 by vapor deposition. The second refractive index film layer 22 is one of the following: a zirconium dioxide (ZrO₂) film layer, a titanium dioxide (TiO₂) film layer, a titanium (III) oxide (Ti₂O₃) film layer, and a titanium (III, V) oxide (Ti₃O₅) film layer. The rest of the first refractive index film layers 21 are one of the following: a silicon monoxide film layer, a silicon dioxide film layer, and a composite film layer of silicon monoxide and silicon dioxide.

The waterproof coating 3 is coated on the film layer assembly 2, so that the film layer assembly 2 is located between the waterproof coating 3 and the substrate 1. Specifically, the main component of the waterproof coating 3 is fluoride.

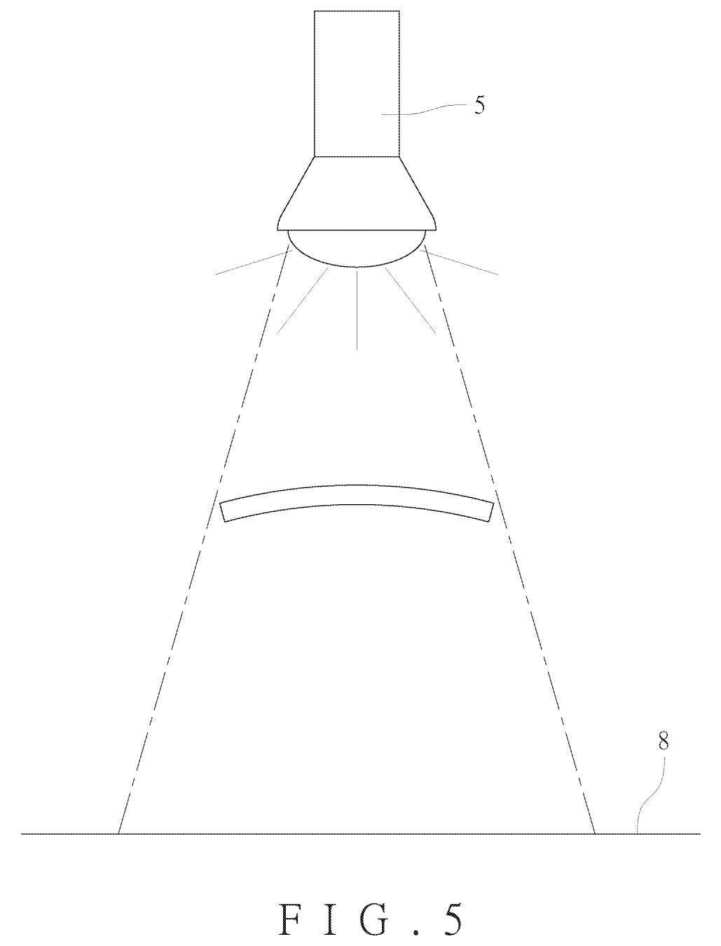

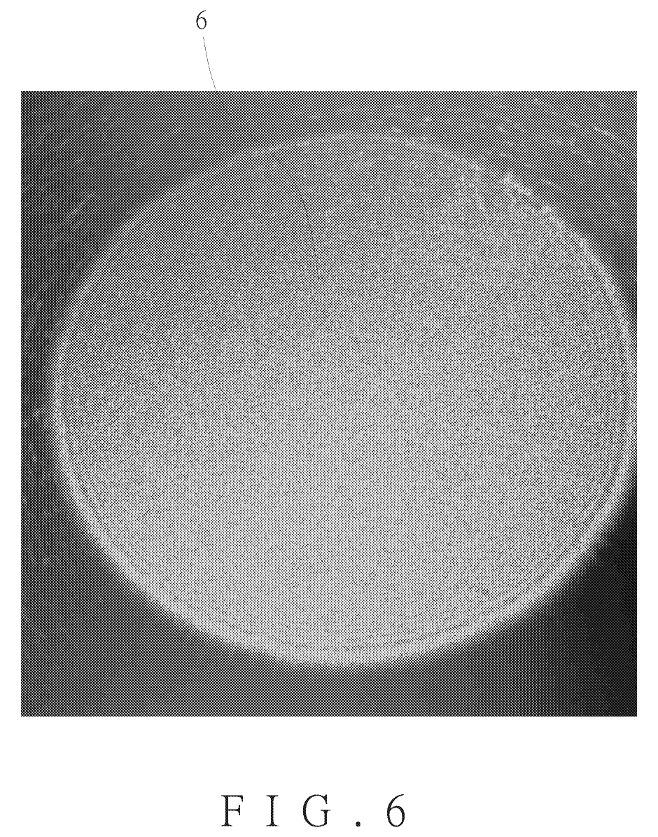

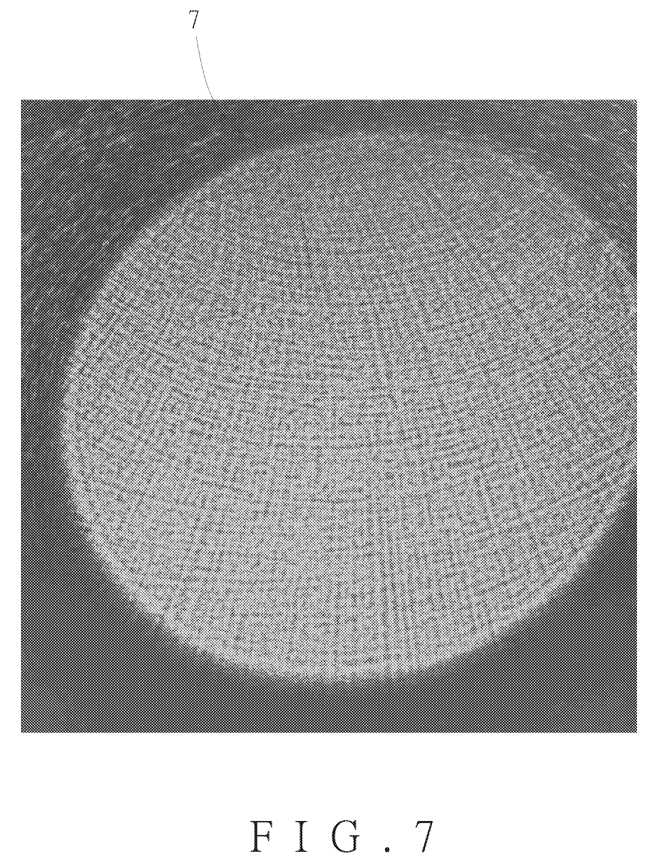

Referring to FIGS. 5-7, the high-temperature resistant lens structure of the present invention and a conventional lens without the components containing 5wt% to 15wt% Ta₂O₅ and 85wt% to 95wt% SiO₂ as described in the present invention are placed in water and heated to boiling for more than 2 minutes. After they are taken out and cooled to room temperature, a light source 5 is used to illuminate the lenses so that the images of the lenses are projected onto a plane 8, and texture changes of the different images are compared. FIG. 6 shows a first image 6 generated by the light source 5 passing through the lens of the present invention. In the first image 6, it can be seen that no shadows or other textures are presented in the first image 6 by irradiating the light source 5. As can be seen from the smooth first image 6, the high-temperature resistant lens structure of the present invention can maintain a smooth surface when heated by boiling water for more than two minutes, and the high temperature does not affect the light transmission of the lens itself. FIG. 7 shows a second image 7 generated by the light source 5 passing through the conventional lens. In this second image 7, a lattice-like shadow can be seen, indicating that the films of the lens have been affected by temperature and cracked. When the light source 5 passes through the lens, it is obscured by the cracks so that a lattice-like shadow is presented in the second image 7.

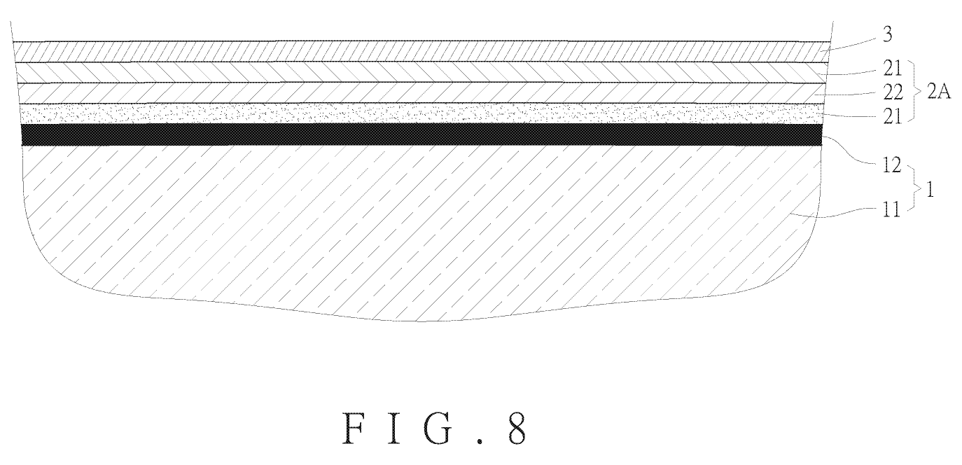

FIG. 8 illustrates a second embodiment of the present invention. A film layer assembly 2A includes three film layers consisting of two first refractive index film layers 21 and one second refractive index film layer 22. Besides, one or both of the first refractive index film layers 21 contain 5wt% to 15wt% of Ta₂O₅ and 85wt% to 95wt% of SiO_{2.} Specifically, when the three film layers are formed by vapor deposition, one of the first refractive index film layers 21, the second refractive index film layer 22 and the other the first refractive index film layer 21 are formed in sequence by vapor deposition.

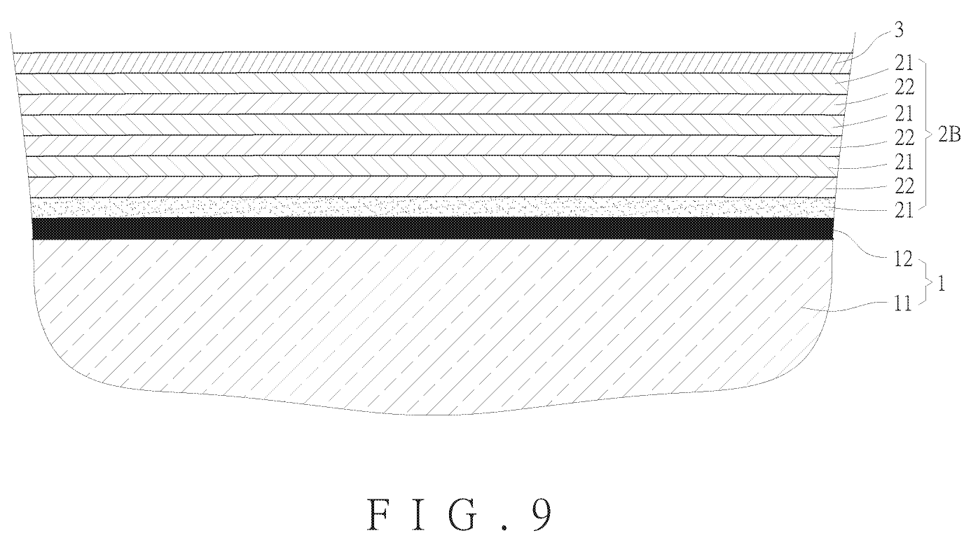

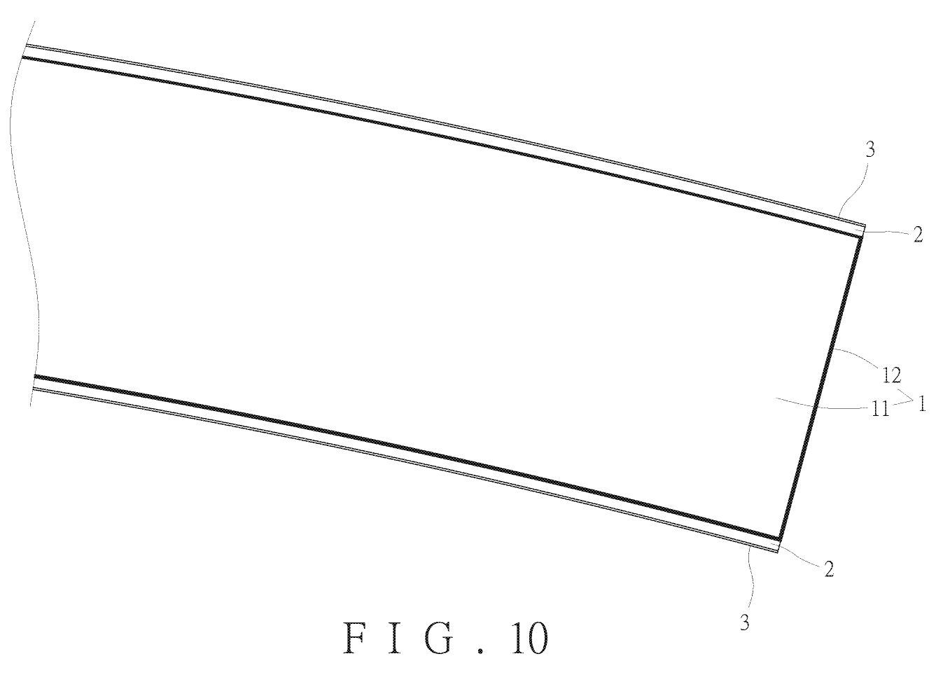

FIG. 9 illustrates a third embodiment of the present invention. A film layer assembly 2B includes seven film layers consisting of four first refractive index film layers 21 and three second refractive index film layers 22. Besides, at least one or all of the first refractive index film layers 21 contain 5wt% to 15wt% of Ta₂O₅ and 85wt% to 95wt% of SiO_{2.} Specifically, when the seven film layers are formed by vapor deposition, the first refractive index film layer 21, the second refractive index film layer 22, the first refractive index film layer 21, the second refractive index film layer 22, the first refractive index film layer 21, the second refractive index film layer 22 and the last first refractive index film layer 21 are formed in sequence by vapor deposition. In the above embodiments, different numbers of film layers are formed on the same side of the substrate 1 by vapor deposition. FIG. 10 illustrates a fourth embodiment of the present invention. Either side of the substrate 1 is formed with the film layer assembly 2 by vapor deposition and the waterproof coating 3. The structure and configuration of the film layer assembly 2 and the waterproof coating 3 are the same as those of the first embodiment of the present invention, and will not be described again.

The high-temperature resistant lens structure provided by the present invention not only adapts to high-temperature environments but also has the ability to emit mid-infrared rays. It can block blue light, infrared light, and harmful ultraviolet rays with reflective properties, thereby protecting the user’s eyes. In addition, the emission of mid-infrared rays helps promote blood circulation in the eyes and accelerates metabolism.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A high-temperature resistant lens structure, comprising:
a substrate, having a substrate body and a hardened layer, the hardened layer covering the substrate body;
at least one film layer assembly, coated on one side of the substrate, the film layer assembly including at least two first refractive index film layers and at least one second refractive index film layer, the first refractive index film layer having a refractive index lower than that of the second refractive index film layer, one of the first refractive index film layers, the second refractive index film layer, and the other first refractive index film layer being arranged on the substrate in sequence, at least one of the first refractive index film layers containing 5wt% to 15wt% of Ta₂O₅ and 85wt% to 95wt% of SiO₂; and
a waterproof coating, coated on the film layer assembly.

2. The high-temperature resistant lens structure as claimed in claim 1, wherein the at least two first refractive index film layers include a plurality of first refractive index film layers, the at least one second refractive index film layer includes a plurality of second refractive index film layers, and the first refractive index film layers and the second refractive index film layers are alternately coated in sequence and then a last one of the first refractive index film layers is coated.

3. The high-temperature resistant lens structure as claimed in claim 1, wherein the refractive index of the first refractive index film layer is between 1.4 and 1.5, and the refractive index of the second refractive index film layer is between 1.8 and 2.5.

4. The high-temperature resistant lens structure as claimed in claim 1, wherein the hardened layer is added with a far-infrared material or a far-infrared composite material, the far-infrared material is one of the following: magnesium oxide (MgO), calcium oxide (CaO), barium oxide (BaO), zirconium dioxide (ZrO₂), titanium dioxide (TiO₂), chromium (III) oxide (Cr₂O₃), manganese dioxide(MnO₂), iron(III) oxide (Fe₂O₃), aluminum oxide (Al₂O₃), carbide, silicide, boride, nitride, tantalum(Ta), molybdenum (Mo), tungsten (W), iron (Fe), nickel (Ni), platinum (Pt), copper (Cu), and gold(Au), and the far-infrared composite material is a mixture of the far-infrared material and zinc oxide(ZnO).

5. The high-temperature resistant lens structure as claimed in claim 1, wherein the second refractive index film layer is one of the following: a zirconium dioxide (ZrO₂) film layer, a titanium dioxide (TiO₂) film layer, a titanium(III) oxide (Ti₂O₃) film layer, and a titanium(III,V) oxide(Ti₃O₅) film layer; and the rest of the first refractive index film layers is one of the following: a silicon monoxide film layer, a silicon dioxide film layer, and a composite film layer of silicon monoxide and silicon dioxide.
